(19) United States
(12) Patent Application Publication
(10) Pub. No.: US 2008/0129535 A1
(43) Pub. Date: Jun. 5, 2008

(54) Method And Apparatus For Implementing Automatic Display Of Help Information With Detection Of Error Condition For Meter Connection

(75) Inventors: Brian C. Thompson, Osceola, IN (US); Robert Trzybinski, Granger, IN (US)

Correspondence Address: NIXON PEABODY LLP, 161 N. CLARK STREET, 48TH FLOOR, CHICAGO, IL, 60601, US

(73) Assignee: BAYER HEALTHCARE LLC

(21) Appl. No.: 11/792,575

(22) PCT Filed: Dec. 12, 2005
(86) PCT No.: PCT/US05/44848

§ 371 Date: Jun. 7, 2007

Related U.S. Application Data
(60) Provisional application No. 60/635,676, filed on Dec. 13, 2004.

(51) Int. Cl. G08B 21/00

(52) U.S. Cl. 340/870.02

(57) ABSTRACT

A method and apparatus are provided for implementing automatic display of assistance information in a data collection computer system. A predefined port is monitored to detect the connection of a meter. When a meter connection is identified and the meter is not communicating properly, assistance information is automatically displayed for the user. A switch is provided for electromechanically detecting when an attempt is being made to connect a meter of a user selected type to a serial port of the data collection computer system. Then help information is automatically displayed when an error is detected.

### FIELD OF THE INVENTION

The present invention relates generally to the biosensors, and more particularly, relates to a method and apparatus for implementing automatic detection of a meter connection, such as, a blood glucose meter, and automatic display of assistance information when the meter is not communicating properly.

### DESCRIPTION OF THE RELATED ART

The quantitative determination of analytes in body fluids is of great importance in the diagnoses and maintenance of certain physiological abnormalities. For example lactate, cholesterol and bilirubin should be monitored in certain individuals. In particular, the determination of glucose in body fluids is of great importance to diabetic individuals who must frequently check the level of glucose in their body fluids as a means of regulating the glucose intake in their diets. While the remainder of the disclosure herein will be directed towards the determination of glucose, it is to be understood that the procedure and apparatus of this invention can be used with other diagnostic systems.

Home glucose monitoring by diabetics is becoming increasingly routine in modern-day diabetes management. Historically, patients were required to maintain handwritten paper log books for manually recording glucose readings and other relevant information. More specifically, patients measured their blood glucose at scheduled times, and recorded this information in a personal log book.

Known diagnostic systems, such as blood glucose systems, include a biosensor used to calculate the actual glucose value based on a measured output and the known reactivity of the reagent sensing element used to perform the test. The test results typically are displayed to the user and stored in a memory in the blood glucose meter. In some known systems, the multiple stored values from the blood glucose meter are periodically transferred to a separate computer, for example to enable analysis by a doctor for the blood glucose monitor user.

While the introduction of glucose meters with various memory functions has greatly simplified the data recording process and increased the reliability of stored data, the large amounts of recorded data have made the interpretation task complicated. It is also possible with present-day devices for patients to record other clinically relevant data such as diet and exercise factors, and life-style information. All such stored data can conveniently be transferred to a physician's office, typically via a communications link such as a direct meter cable connection or an acoustic modem line, where it can be reviewed in printed or displayed form for making appropriate treatment recommendations.

Many traditional approaches to automated analysis of diabetes data provide a relatively superficial analysis and an assortment of graphical displays based upon certain predefined statistical calculations. However, the time-consuming and complicated synthesis and interpretation of clinical implications associated with the processed data still need to be performed by the reviewing physician, and significant interaction is still required on behalf of the physician.

U.S. Pat. No. 5,251,126 issued Oct. 5, 1993 to Kahn et al., and assigned to the present assignee discloses an automated diabetes data interpretation method referred to as the “IDDI” system, that combines symbolic and numeric computing approaches to identify and highlight key clinical findings in the patient's self-recorded diabetes data. The patient data, including blood glucose levels and insulin dosage levels, recorded by a diabetic patient over a period of time by means of a glucose meter or the like, is initially downloaded into a central processing system such as a personal computer. The accepted diabetes data is processed to (a) identify insulin dosage regimens corresponding to predefined significant changes in insulin dosage which are found to be sustained for at least a predefined segment of the overall data collection period, (b) identify statistically significant changes in blood glucose levels resulting across adjacent ones of the identified insulin regimen periods, and (c) identify clinically significant changes in blood glucose levels from within the identified statistically significant glucose level changes. The results of the diabetes data processing are generated in the form of a comprehensive yet easily understandable data interpretation report highlighting the processing results, including details pertaining to the identified insulin regimens and the associated clinically significant changes in glucose levels.

Multiple commercially available clinical analyzers are available for patient use. Due to differences between various commercially available clinical analyzers, a health care professional (HCP) must have compatible software to run, or may require the patient to be present in the HCP's office if the patient does not have the same or similar program at home. The HCP must run the program, switch cables to match the meter, and maintain both hardware and software. Such chores tend to be time consuming and inefficient.

A need exists for an improved method and apparatus for implementing data management to aid analysis and treatment by the patient's doctor or HCP and to minimize time required, for example, in running software, switching cables, and downloading meters.

### SUMMARY OF THE INVENTION

Important aspects of the present invention are to provide a new and improved method and apparatus for implementing data management to aid analysis and treatment including automatic detection of a meter connection, such as, a blood glucose meter and automatic display of assistance information when the meter is not communicating properly; and to provide such method and apparatus for implementing automatic display of assistance information that overcome some disadvantages of prior art arrangements.

In brief, a method and apparatus are provided for implementing automatic display of assistance information in a data collection computer system. A serial port is monitored to detect the connection of a meter. When a meter connection is identified and the meter is not communicating properly, assistance information is automatically displayed for the user.

In accordance with features of the invention, a switch is provided for electromechanically detecting when an attempt is being made to connect a meter of a user selected type to the serial port of the data collection computer system. Help information is then automatically displayed when an error is detected.

### BRIEF DESCRIPTION OF THE DRAWINGS

The present invention together with the above and other advantages may best be understood from the following detailed description of the preferred embodiments of the invention illustrated in the drawings, wherein:

FIG. 1A illustrates an exemplary data collection computer system for implementing automatic detection of a meter connection and automatic display of help information in accordance with the present invention.

FIG. 1B is a logical block diagram representation of the data collection computer system of FIG. 1A for implementing automatic detection of a meter connection and automatic display of help information in accordance with the present invention.

FIG. 1C is a block diagram representation illustrating electromechanical detection apparatus of the data collection computer system of FIG. 1A for implementing automatic detection of a meter connection and automatic display of help information in accordance with the present invention.

FIG. 2 is a flow chart illustrating exemplary steps performed by the data collection computer system of FIGS. 1A, 1B and 1C in accordance with the automatic meter detection and help information display methods in accordance with the present invention.

### DETAILED DESCRIPTION OF THE PREFERRED EMBODIMENT

In accordance with features of the invention, a method is provided for implementing automatic meter detection and automatic display of help information when an error is detected. The present invention solves a problem of the prior art by providing automatic display of help information to guide the user for properly connecting a meter that is being connected to a serial port of a data collection computer system before full communication is established with the meter. The data collection computer system monitors at least one serial port for the presence of a blood glucose meter in one embodiment. Upon detection of a blood glucose meter being attached and the meter is not communicating properly, assistance information is automatically displayed for the user.

In accordance with features of the invention, when a meter attempts to make a connection on a serial RS232 port, this meter depresses a pressure switch. The switch when depressed, for example, connects together the DSR and DTR lines on the data collection computer; and this activates the DSR line electronically. The protocol software running on the computer picks up the signal and recognizes the fact that a meter is trying to make a contact via the serial port. Based on the type of meter, the system can alert the user about any communication problems and guide the user on the acts required to initiate communications or correct the problem.

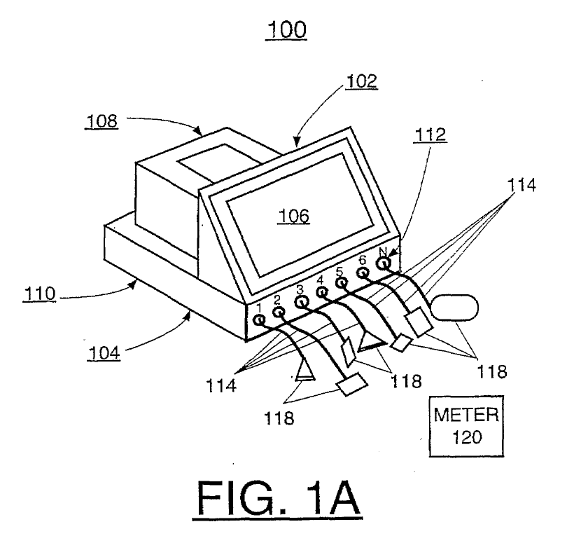

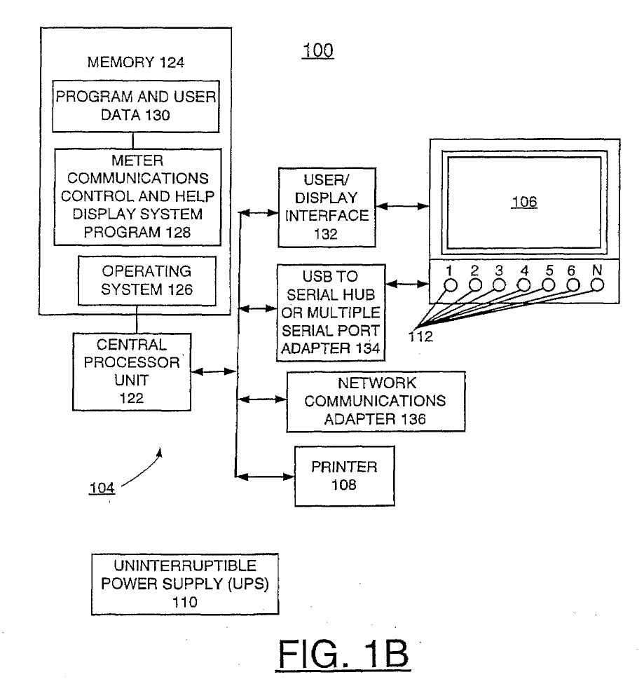

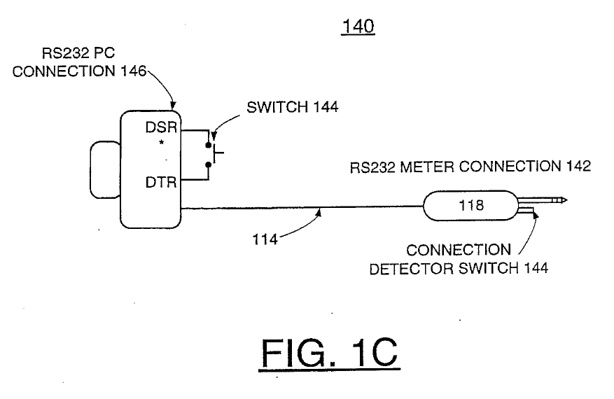

Having reference now to the drawings, in FIGS. 1A, 1B and 1C, there is illustrated an exemplary computer system designated as a whole by the reference character 100 and arranged in accordance with principles of the present invention. Data collection computer system 100 includes a housing generally designated by reference character 102 containing a computer 104, a display touch screen 106, a printer 108, and an optional uninterruptible power supply 110. Data collection computer system 100 is a unitary system typically located in an office of a health care professional (HCP). Data collection computer system 100 is arranged for use by patients without requiring assistance from any HCP.

As shown, data collection computer system 100 includes a plurality of ports 1-N, 112, each receiving a respective cable 114. An associated connector 118 is provided with each of the plurality of cable 1-N, 114 for electrically connecting with a particular meter 120. Each of the multiple connectors 118 is arranged for use with a particular one of multiple meter types.

The meter 120, such as a biosensor or glucose meter 120 is used by a patient and periodically receives and processes a user sample from the patient, then stores or records the measured blood glucose (BG) levels. The meter 120 is attached to its specific cable 1-N, 114 via the associated connector 118 mating with the meter. Some blood glucose meters must be turned on in order to communicate with the data collection computer system 100.

Referring also to FIG. 1B, computer 104 includes a central processor unit (CPU) 122 together with an associated memory 124. Computer 104 includes an operating system 126, a meter communications control and IDDI system program 128 of the preferred embodiment, and program and user data 130 of the preferred embodiment resident in memory 124. Computer 104 includes a user/display interface 132 that couples the display touch screen 106 to the CPU 122, and a USB to serial hub or multiple serial port adapter 134 that couples an attached meter 120 to the CPU 122. Computer 104 includes a network communications adapter 136 for connection, for example, to another computer (not shown) in the doctor's office.

Data collection computer system 100 is shown in simplified form sufficient for understanding the present invention. The illustrated computer test system 100 is not intended to imply architectural or functional limitations. The present invention can be used with various hardware implementations and systems and various other internal hardware devices.

Referring also to FIG. 1C, computer 104 includes an electromechanical detection apparatus generally designated by reference character 140 for implementing automatic detection of a meter connection and automatic display of help information in accordance with the present invention. Electromechanical detection apparatus 140 includes one associated connector 118 provided with a respective cable 114 for providing an RS-232 meter connection 142 and a connection detection switch 144. The connection detection switch 144 is coupled between a data set ready (DSR) and a data terminal ready (DTR) of an RS-232 PC connection 146. The connection detection switch 144, when depressed, connects the DSR and DTR lines together at the RS-232 PC connection 146, as schematically shown. The momentary connection to the DSR and DTR lines at the RS-232 PC connection 146 notifies the CPU 122 that a meter 120 has been connected via one of the cables 114 using the standard function of a wire in the serial handshake protocol. In response to being informed of the connection of a meter 120, the system 100 will attempt to identify the meter by communicating with it over the serial port connection 146.

The meter communications control and IDDI system program 128 directs the data collection computer system 100 to send a communication initiation packet to the serial port RS-232 PC connection 146 in accordance with the preferred embodiment. If communication is unsuccessful or the meter type is identified as not matching the meter type selected by the user, appropriate help information is displayed to the user. For example, when an error is detected, instructions are displayed on display 106 for the meter's user, such as, turn on the meter, cable bad, wrong cable used, cable is not properly connected. Such instructions are displayed on display 106 without communication between the CPU 122 and the meter 120.

The meter communications control and IDDI system program 128 automatically detects when a meter connection is attempted and the meter is not communicating properly; and then automatically displays assistance information for the user. The meter communications control and IDDI system program 128 also automatically download patient data and print out data and reports and includes the automated intelligent diabetes data interpretation (IDDI) software functions necessary to process, analyze and interpret the self-recorded diabetes patient data and generate selected reports.

U.S. Pat. No. 5,251,126 issued Oct. 5, 1993 to Kahn et al., and assigned to the present assignee, discloses an IDDI system that advantageously included in the IDDI software functions of the meter communications control and IDDI system program 128 in the data collection computer system 100. The subject matter of the above-identified U.S. Pat. No. 5,251,126 is incorporated herein by reference in its entirety.

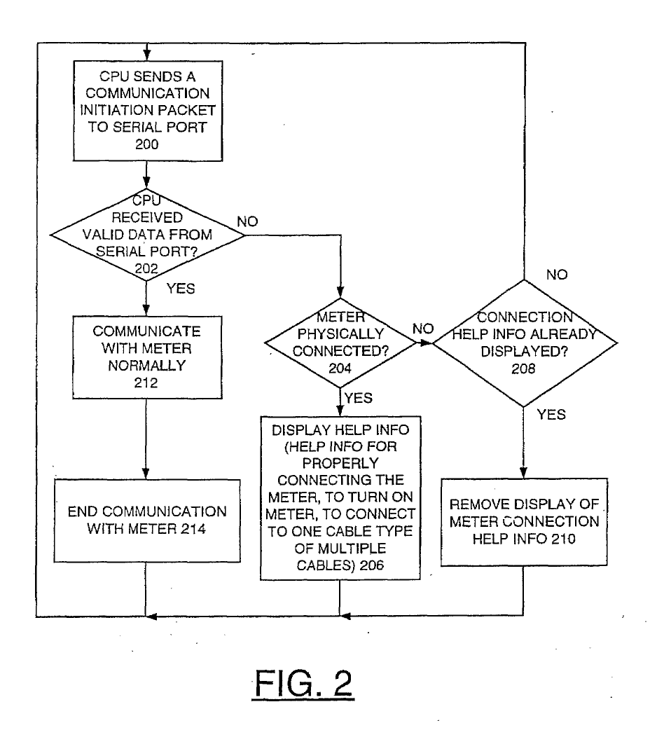

Referring now to FIG. 2, there are shown exemplary steps performed by the data collection computer system 100 of FIGS. 1A, 1B and 1C in accordance with the automatic meter detection and help information display methods in accordance with the present invention. In accordance with features of the invention, the meter communications control and IDDI system program 128 attempts to communicate with an attached blood glucose meter 120 by utilizing commands that the blood glucose meter normally responds or acknowledges.

As indicated in a block 200, CPU 122 sends a communication initiation packet to the serial port. Checking for valid data being received from the serial port is performed as indicated in a decision block 202. When a valid data acknowledgement response from the blood glucose meter 120 is not identified, checking for a meter 120 being physically connected is performed as indicated in a decision block 204. When a meter 120 is detected, then help information is displayed, for example, for properly connecting the meter, or simply to turn on the meter, as indicated in a block 206. If determined at decision block 204 that a meter 120 is not physically connected, then checking if connection help information has already been displayed is performed as indicated in a decision block 208. If connection help information has already been displayed, then the display of connection help information is removed as indicated in a block 210. Otherwise the operations return to block 200 for sending a communication initiation packet.

Once a valid data response is received, the program 128 knows that a meter is attached and the program 128 then proceeds to communicate with the meter normally as indicated in a block 212, for example, to download stored patient data without requiring a key press or any user entry to the data collection computer system 100. Once the data is downloaded, the program 128 communicates with the meter 120 using commands that the blood glucose meter 120 normally responds. As indicated in a block 214, the program 128 ends communications with the blood glucose meter, for example, when the meter is turned off, the cable is disconnected, or the meter automatically shuts itself off after a specific amount of inactivity.

Alternate Process A

A method for implementing automatic display of assistance information in a data collection computer system, the method comprising the acts of:

monitoring a predefined port to detect the connection of a meter;

identifying an error when the meter is not communicating properly; and

responsive to a meter connection being identified and an error being identified, automatically displaying assistance information by the data collection computer system.

Alternate Process B

A method of Alternate Process A wherein the act of monitoring a predefined port to detect the connection of a meter includes the acts of monitoring a predefined serial port of the data collection computer system for detecting the connection of a meter.

Alternate Process C

A method of Alternate Process A wherein the act of monitoring a predefined port to detect the connection of a meter includes the acts of sending a communication initiation packet to the predefined port, and checking for a valid data acknowledgement response from a meter.

Alternate Process D

A method of Alternate Process A wherein the act of monitoring a predefined port to detect the connection of a meter includes the acts of monitoring a predefined serial port of the data collection computer system for detecting the connection of a meter; and providing a pressure switch together with a meter connector, the pressure switch being depressed by the connection of a meter to the meter connector.

Alternate Process E

A method of Alternate Process D further including the act of providing a predefined serial port signal responsive to said pressure switch being depressed.

Alternate Process F

A method of Alternate Process E further including the acts of sending a communication initiation packet to the predefined serial port, and checking for a valid data acknowledgement response from a meter.

Alternate Process G

A method of Alternate Process E wherein the acts of providing a predefined serial port signal responsive to said pressure switch being depressed includes the act of providing a data set ready (DSR) signal responsive to the pressure switch being depressed.

Alternate Process H

A method of Alternate Process A wherein the act of automatically displaying assistance information includes the acts of displaying predefined instructions for a user when the meter fails to provide a valid data acknowledgement response.

Alternate Process I

A method of Alternate Process H includes the act of displaying instructions for a user to turn on the meter.

Alternate Process J

A method of Alternate Process H includes the act of displaying instructions for connecting the meter to one cable of a plurality of cables.

### Alternate Embodiment K

Apparatus for implementing automatic display of assistance information in a data collection computer system comprising:

a processor for monitoring a predefined port to detect the connection of a meter;

said processor for sending a communication initiation packet to the predefined port;

said processor for identifying an error when the meter is not communicating properly; and

said processor responsive to a meter connection being identified and an error being identified, for automatically displaying of assistance information.

### Alternate Embodiment L

The apparatus of Alternate Embodiment K further including a memory coupled to said processor device, the memory for storing a meter communications control and intelligent diabetes data interpretation (IDDI) system program.

### Alternate Embodiment M

The apparatus of Alternate Embodiment K further including a display screen coupled to said processor device for displaying of said assistance information.

### Alternate Embodiment N

The apparatus of Alternate Embodiment K further including a meter connector and a pressure switch provided together with the meter connector, the pressure switch being depressed by the connection of a meter to the meter connector.

### Alternate Embodiment O

The apparatus of Alternate Embodiment N wherein the predefined port includes a predefined serial port; and wherein a predefined serial port signal is provided responsive to the pressure switch being depressed by the connection of a meter to the meter connector.

### Alternate Embodiment P

The apparatus of Alternate Embodiment O wherein the predefined serial port signal includes a data set ready (DSR) signal being provided responsive to the pressure switch being depressed.

While the present invention has been described with reference to the details of the embodiments of the invention shown in the drawing, these details are not intended to limit the scope of the invention as claimed in the appended claims.

1. A method for implementing automatic display of assistance information in a data collection computer system, the method comprising the acts of:
monitoring a predefined port to detect the connection of a meter;
identifying an error when the meter is not communicating properly; and
responsive to a meter connection being identified and an error being identified, automatically displaying assistance information by the data collection computer system.

2. A method of claim 1, wherein the act of monitoring a predefined port to detect the connection of a meter includes the acts of monitoring a predefined serial port of the data collection computer system for detecting the connection of a meter.

3. A method of claim 1, wherein the act of monitoring a predefined port to detect the connection of a meter includes the acts of sending a communication initiation packet to the predefined port, and checking for a valid data acknowledgement response from a meter.

4. A method of claim 1, wherein the act of monitoring a predefined port to detect the connection of a meter includes the acts of monitoring a predefined serial port of the data collection computer system for detecting the connection of a meter; and providing a pressure switch together with a meter connector, the pressure switch being depressed by the connection of a meter to the meter connector.

5. A method of claim 4, further including the act of providing a predefined serial port signal responsive to said pressure switch being depressed.

6. A method of claim 5, further including the acts of sending a communication initiation packet to the predefined serial port, and checking for a valid data acknowledgement response from a meter.

7. A method of claim 5, wherein the acts of providing a predefined serial port signal responsive to said pressure switch being depressed includes the act of providing a data set ready (DSR) signal responsive to the pressure switch being depressed.

8. A method of claim 1, wherein the act of automatically displaying assistance information includes the acts of displaying predefined instructions for a user when the meter fails to provide a valid data acknowledgement response.

9. A method of claim 8, includes the act of displaying instructions for a user to turn on the meter.

10. A method of claim 8, includes the act of displaying instructions for connecting the meter to one cable of a plurality of cables.

11. Apparatus for implementing automatic display of assistance information in a data collection computer system comprising:
a processor for monitoring a predefined port to detect the connection of a meter;
said processor for sending a communication initiation packet to the predefined port;
said processor for identifying an error when the meter is not communicating properly; and
said processor responsive to a meter connection being identified and an error being identified, for automatically displaying of assistance information.

12. The apparatus of claim 11, further including a memory coupled to said processor device, the memory for storing a meter communications control and intelligent diabetes data interpretation (IDDI) system program.

13. The apparatus of claim 11, further including a display screen coupled to said processor device for displaying of said assistance information.

14. The apparatus of claim 11, further including a meter connector and a pressure switch provided together with the meter connector, the pressure switch being depressed by the connection of a meter to the meter connector.

15. The apparatus of claim 14, wherein the predefined port includes a predefined serial port; and wherein a predefined serial port signal is provided responsive to the pressure switch being depressed by the connection of a meter to the meter connector.

16. The apparatus of claim 15, wherein the predefined serial port signal includes a data set ready (DSR) signal being provided responsive to the pressure switch being depressed.
